(19) United States
(12) Patent Application Publication
(10) Pub. No.: US 2010/0029507 A1
(43) Pub. Date: Feb. 4, 2010

(54) THE BIOCHIP FOR THE DETECTION OF PHOSPHORYLATION AND THE DETECTION METHOD USING THE SAME

(75) Inventors: Sang Hyun Park, Daejeon (KR); Hui Jeong Gwon, Daejeon (KR); Kyong Cheol Ko, Jeju-do (KR); Myung Woo Byun, Daejeon (KR)

Correspondence Address: LUCAS & MERCANTI, LLP, 475 PARK AVENUE SOUTH, 15TH FLOOR, NEW YORK, NY, 10016, US

(73) Assignee: KOREA ATOMIC ENERGY RESEARCH INSTITUTE, Daejeon (KR)

(21) Appl. No.: 11/776,969

(22) Filed: Jul. 12, 2007

(30) Foreign Application Priority Data
Jul. 12, 2006 (KR) 10-2006-0065146

(51) Int. Cl. C40B 30/08; C40B 40/10

(52) U.S. Cl. 506/11; 506/18

(57) ABSTRACT

The present invention relates to a biochip for the detection of phosphorylation and a method for measuring phosphorylation using the same, more precisely a biochip integrated with the substrate of kinase and a kit for measuring phosphorylation comprising the biochip and a radio-labeled co-factor, and a method for measuring phosphorylation using the same. The kit for the detection of phosphorylation of the present invention facilitates simple and fast measurement of phosphorylation with a minimum amount of a sample, compared with the conventional method using an antibody, because it uses a radioisotope. This chip and kit can be effectively used for the analysis of kinase activity since this method favors fast mass analysis.

### BACKGROUND OF THE INVENTION

(a) Field of the Invention

The present invention relates to the biochip for the detection of phosphorylation and the detection method using the same, more precisely the biochip composed of a biochip integrated with a kinase substrate and a radioisotope-labeled cofactor and the detection method using the same.

(b) Description of the Related Art

As the recent biotechnology industry brings miniaturization in relief, it is a trend to integrate electronic, computational and mechanical technologies to the conventional biological studies. Biological studies also require a new systemic research that enables the overall approach of unit organism so as to execute a variety of experiments with an infinitesimal experimental sample. Thus, it is expected that a biochip can act as a key factor for bioinformatics and its techniques based on genes, proteins, and cells, etc.

Upon completion of the human genome project, studies on the micro analysis system such as a DNA chip or a protein chip have been actively going on for the analysis of genes, proteins or cells in the overall biological industry. It is also expected that the market of such biochips will be huge. Thus, it is strongly requested in Korea as well to develop biochips as a representative product of bio-industry.

A protein chip or peptide chip has been known as a second generation biosensor that is able to simultaneously analyze protein bindings on a small board on which tens thousands of peptides are loaded, which means it has completely different analysis system and applied field from the conventional DNA chip. The protein chip is a key technique for the study to develop a novel therapeutic and preventive method for serious disease that is incurable with the conventional methods because the protein chip is able to disclose the functions of a protein specific biomolecule and analyze protein functions and networks.

Protein chip technology can be classified into three core techniques; protein microarray in relation to the production of the chip; analysis technique to measure and compare the interaction between proteins by observing the proteins fixed by the array; and application technique of the protein chip. Preparing method for the protein chip is in a variety according to the chip analysis technique. For example, when SPR (Surface Plasmon Resonance) is used, which means proteins have to be fixed on gold thin film, both gold thin film production technique and protein fixation technique are equally necessary. When a fluorescent material is used, it is important to label a target protein with the fluorescent material because the analysis is performed with the protein directly fixed on a slide glass.

As for the protein chip analysis techniques, Nano-Imaging such as Ellipsometry is now under the development in addition to the already established SPR, mass spectrometry, fluorescence analysis method and electrochemical analysis method. There is, in fact, competition in developing the analysis techniques. Up to date, fluorescence analysis method has been most widely used but each method has merits and demerits, and thus it is hard to tell which analysis method is the most appropriate for diagnosing a certain disease and a satisfactory protein chip based analysis system has not been established, yet.

The application of such protein chip is wide open for the studies since this is still an unexplored filed for which active research has not been attempted yet.

Most recent techniques regarding protein chip are largely classified into following four.

(1) First is the technique to analyze interaction between DNA and protein on a chip using DNA microarray. On a chip, a single stranded oligonucleotide is converted into a double stranded oligonucleotide, which is reacted with a specific DNA sequence specific restriction enzyme. Then, DNA-protein interaction is investigated by detecting the digestion. This technique is useful to screen a novel DNA binding protein and to discover the characteristics thereof (Bulyk, M. L. et al., Nature. Biotechnol., 17:573-577, 1999).

(2) Second is the technique to analyze various enzymes such as restriction enzyme, peroxidase, phosphatase and protein kinase, etc, and antigen-antibody reaction on a chip (US Patent Publication No. UO 2002/0055186A1; WO 01/83827A1; Braunwalder A. et al., Anal. Biochem., 234:23-26, 1996; Houseman B. et al., Nature Biotechnol., 20:270-274, 2002; Ruud M. et al., Nature Biotechnol., 18:989-994, 2000). In particular, this technique is useful for the mass-measurement, biochemical analysis, screening a candidate for a new drug, and diagnosis for a disease, based on the investigation of protein-protein interaction, kinase-peptide substrate reaction, and protein-ligand coupling reaction. However, if kinase-specific peptides or proteins having a low molecular weight are fixed, a blocking material preventing non-specific fixation such as bovine serum albumin (BSA) has to be used, which might bury the major materials to be fixed. Besides, when different antibodies were fixed on a chip and reacted with fluorescent-labeled antigen mixture, only 60% of the antibodies showed quantitative result and only 23% of them showed qualitative result (MacBeath G. et al., Science, 289:1760-1763, 2000; Haab B. et al., Genome Biol. 2:research 0004, 2001).

(3) Third is the technique to induce mass-expression of a protein from cDNA library and analyze them (WO 01/83827, WO 02/50260). This technique is very useful for the mass-measurement of biochemical activity of a protein (Heng Zhu, et al., Nature genetics, 26:283-289, 2000).

(4) Fourth is the technique to analyze a sample by regulating orientation of biomolecule at molecular level by using an affinity tag and by forming an even and stable monolayer of the biomolecule on the surface of a chip (US Patent Publication No. UO 2002/0055125A1; U.S. Pat. No. 6,406,921; Paul J. et al., JACS, 122:7849-7850, 2000; RaVi A. et al., Anal. Chem., 73:471-480, 2001; Benjamin T. et al., Tibtech., 20:279-281, 2002). For example, a protein is expressed as the form of His-tag fusion form and then fixed on a chip attached with Ni-NTA functional group. In this case, the activity of the biomolecule is maintained and/or the protein is expressed in the form of intein fusion form, so that purification is facilitated and more stable and the activity is maintained by fixing a specific target region in a regular direction on a avidin treated chip (Zhu et al., Science, 293:2101-2105, 2001; Marie-Laure L. et al., JACS 124:8768-8769, 2002). In addition, a protein can be expressed as the form of supporter specific protein (calmodulin, etc) and tag (polycysteine, lysine, histidine, etc) fusion protein and then fixed on a chip, suggesting that this chip can be effectively used for the protein purification, SPR (surface plasmon resonance) and FACS (fluorescence activated cell sorter) based on the investigation of the interaction between proteins (Hentz et al., Anal. Chem., 68:3939-3944, 1996; Hodneland et al., PNAS, 99:5048-5052, 2002; Kukar et al., Anal. Biochem., 306:50-54, 2002; U.S. Pat. No. 6,117,976).

Kinase is a protein that can be a target of a drug since it causes a series of reactions in vivo stepwise by being involved in signal transduction. Kinase is involved in signal transduction pathways in eukaryotic cells and so plays a certain role in development of a disease including cancer by attaching γ-phospho group from ATP provided to serine, threonine and tyrosine residues (Hunter, T., Cell 100:113-127, 2000; Zhang, Z. Y., Curr. Opin. Chem. Biol. 5:416-423, 2001). The conventional method to study the activity of kinase is to use reaction with radioisotope on cell membrane, but this method proceeds very slowly and a bulk of working is required. The conventional method for mass-measurement of kinase and its receptor is ELISA (enzyme-linked immunosorbent assay) and antibody based methods. However, ELISA takes long time and requires huge amount of samples, even if it is comparatively accurate method. In the meantime, the method using an antibody enables mass-measurement but it costs a lot of money and the procedure is very complicated.

Promega, Co (USA) provides the phosphorylation assay kit using radioisotope-labeled ATP, biotinylated kinase substrate and a membrane with high adhesion. However, this kit has limitation in mass-measurement. The company also provides an analysis method using the difference of moving on electrophoresis resulted from net charge of a substrate after phosphorylation of a kinase. This method does not use radioisotope but costs high price for mass-measurement. There has been no other method for mass-screening of the activity of protein kinase using protein chip or peptide chip except the above mentioned 4 methods. Therefore, it is an urgent request to develop a novel system which costs less and is accurate and fast.

The present inventors established optimum conditions for faster and more accurate reaction between a kinase and a substrate on a biochip using radioisotope, and further the inventors completed this invention by confirming phosphorylation by kinase based on the established conditions.

### SUMMARY OF THE INVENTION

It is an object of the present invention to provide a biochip for the detection of phosphorylation that is able to measure phosphorylation faster with smaller amount of samples.

### BRIEF DESCRIPTION OF THE DRAWINGS

FIG. 1 is a diagram illustrating the mechanism of kinase assay:

K: Kinase; and

S: Substrate.

FIG. 2 is a diagram illustrating the reaction mechanism between kemptide and cAMP-dependent protein kinase.

FIG. 3 is a diagram illustrating the reaction on the biochip using a radioisotope.

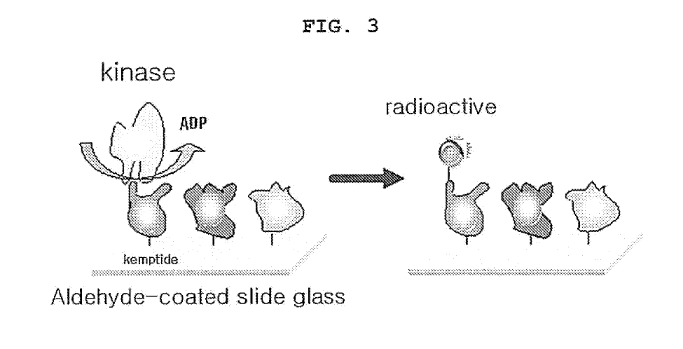

FIG. 4 is a schematic diagram of the biochip.

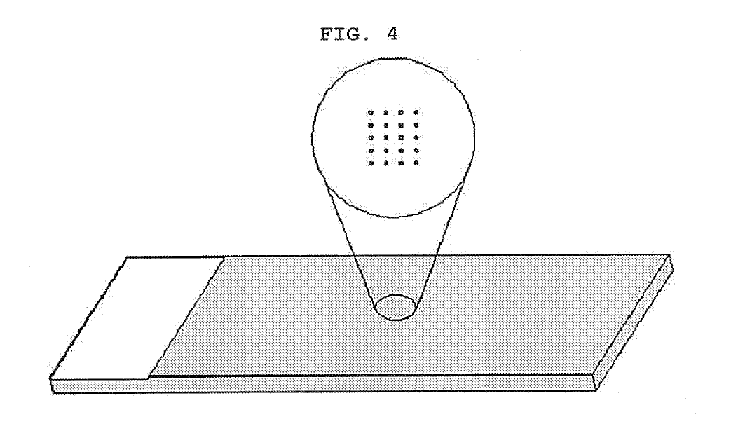

FIG. 5 is a diagram illustrating applicable effectiveness of the biochip using a radioisotope:

1: Negative control (bovine serum albumin, BSA);

2: E. coli malic enzyme-kemptide fusion protein; and

3: Kemptide.

FIG. 6 is a diagram illustrating the comparison of screening methods after phosphorylation.

FIG. 7 is a diagram illustrating the effects of various blocking solutions in phosphorylation using [γ-³²P]ATP:

a: Non-treated;

b: 1% BSA;

c: 1% Glycine;

d: 10% Glycerol;

1: BSA;

2: E. coli malic enzyme-kemptide fusion protein; and

3: Kemptide.

FIG. 8 is a diagram illustrating applicable effectiveness of the biochip using a radioisotope:

1: Negative control (bovine serum albumin, BSA); and

2: Total protein of lysed cell.

### DETAILED DESCRIPTION OF THE PREFERRED EMBODIMENTS

To achieve the above object, the present invention provides a biochip on which substrates are integrated on the surface of a substrate coated with an active group.

The present invention also provides a kit for the detection of phosphorylation comprising the biochip above and [γ-³²P]ATP.

The present invention further provides a method for the detection of phosphorylation using the above kit for the detection of phosphorylation.

In addition, the present invention provides a screening method for the kinase specific substrate using the biochip coated with an active group and kinase mixed with [γ-³² P]ATP.

Hereinafter, the present invention is described in detail.

The present invention provides a biochip on which substrates are integrated on the surface of a substrate coated with an active group and a kit for the detection of phosphorylation comprising the said biochip and [γ-³²P] ATP.

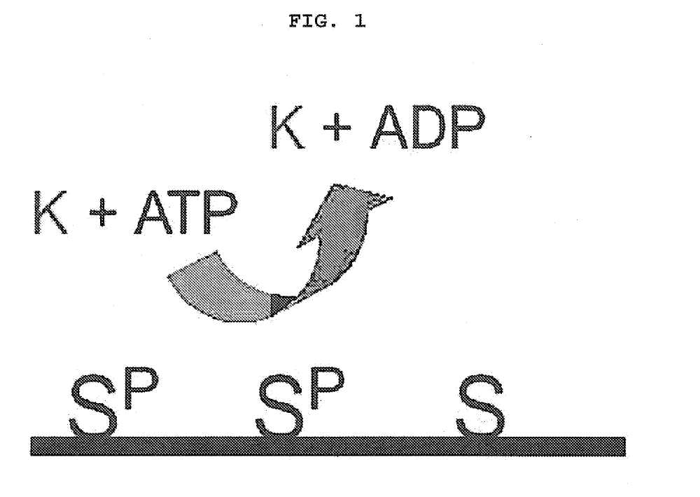

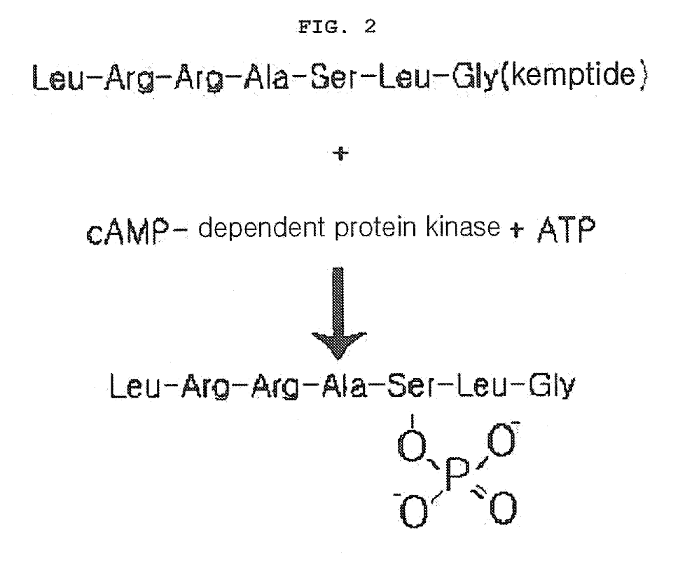

The present inventors confirmed the reaction between kinase and a substrate on the biochip prepared by spotting method (Jonq-Gu Park, J. Biomed. Lab. Sci. 10:75-84, 2004) using the robotic microarrayer (Affymetrix 417 Arrayer (Takara Shuzo, Japan)). The inventors selected a substrate from the group consisting of Kemptide, protein phosphatase inhibitor 2, Elk 1 (p62 ternary complex factor) and kinase to prepare a biochip (Frederic D. Sigoillot, David R. Evans, and Hedeel I. J. Biol. Chem. 277(18):15745-15751, 2002). In the preferred embodiment of the present invention, cAMP-dependent protein kinase was selected and Kemptide was selected as a kinase substrate. As shown in FIG. 2, the cAMP-dependent protein kinase was reacted specifically to Kemptide having 7 specific amino acid sequences to transmit phosphate group of ATP to serine, which takes place largely and frequently in animal cells (see FIG. 1).

The selected substrate was fixed on the surface of the slide glass treated with aldehyde group that is a functional group which is able to fix a protein only, by spotting method using the microarrayer prepared by the present inventors. At this time, the diameter and the distance between spots are up to 1 mm respectively and more preferably about 50 μm and 300 μm. Proteins were distributed by up to 1 μl in the spot range of 1 cm×1 cm. According to the previous reports, 10˜20 μl of substrate proteins are allegedly required to carry out kinase activity assay. However, the biochip of the present invention only requires 1 μl of protein per spot. So, the biochip of the invention uses much smaller amount of substrate. Therefore, approximately 5,000 substrates are integrated on one slide glass biochip of the invention and 5,000 different kinase substrate assays can be performed under the same conditions.

The biochip prepared above was treated with cAMP-dependent protein kinase. For hybridization, kinase buffer, kinase and [γ-³²P]ATP were added to induce kinas-substrate reaction. Phosphorylation by the kinase was measured by sensitizing X-ray film or fluorescence analyzing screen. As a result, it was confirmed that phosphorylation was induced quickly by using a small amount of substrate and kinase. In the case of the conventional biochips, a small amount of substrate could not induce antibody reaction, and thus only fusion protein form could be analyzed (Lee, S J and Lee, S Y., Anal. Biochem. 330:311-316, 2004).

The substrate of the biochip of the kit for the detection of phosphorylation, according to the present invention, is preferably prepared by one of glass, plastic, metal and silicon. In a preferred embodiment of the present invention, glass was selected but not always limited thereto. The active group coated on the substrate of the biochip plays a role in fixation of peptides and is preferably selected from the group consisting of amino group, aldehyde group, carboxyl group and thiol group. In a preferred embodiment of the present invention, aldehyde group was selected but not always limited thereto and any active group known to be able to fix protein molecule on the substrate can be used.

The substrate for the biochip can be selected from the group consisting of kemptide, malic enzyme-kemptide, protein phosphase inhibitor-2, and Elk1. In a preferred embodiment of the present invention, kemptide and malic enzyme-kemptide were used but not always limited thereto and any protein originated from the sample selected from the group consisting of cell culture medium, cell homogenate, crude extract of cells or tissues, various secreting fluids such as urine, sweat, saliva, and tear and body fluids including blood, blood plasma, lymph and serum can be used as a substrate for the biochip of the invention.

In the present invention, the low-molecular polypeptide substrate was fixed on the board efficiently without using a high molecular protein such as malic enzyme that has been generally used as a fusion protein partner to fix a low molecular polypeptide substrate on a board. Thus, the polypeptide substrate used in the present invention can be a fusion protein but it is more preferred to fix a polypeptide substrate itself directly on the board.

The kit for the detection of phosphorylation of the invention is useful for measuring phosphorylation induced by any kinase selected from the group consisting of RAF, VEGFR-2, VEGFR-3, PDGFR-β, KIT, FLT-3 and RET known to be involved in tumor cell proliferation and tumor angioqenesis; BTAK or STK15 known as Aurora kinase found in many solid tumors; Lyn, a tyrosine kinase causing B cell chronic lymphocytic leukemia (B-CLL); PTK (protein tyrosine kinase), MAPK (MAP kinase), MAPKK (MAP kinase kinase), PKA (protein kinase A), PKC (protein kinase C), ERK (extracellular signal-regulated kinase), CAM KΠ (calcium/Calmodulin-dependent protein kinase), MEKK (MAP/ERK kinase kinase), JNK (c-Jun N-terminal kinase), SAPK (stress-activated protein kinase), p38K (p38 kinase), phosphatase 2B, cPKC (conventional protein kinase), Serine Kinase IKKβ, Ab1K (Ab1 kinase), BTK (Bruton tyrosine kinase), CDK (cyclin-dependent kinase), VEGF-RTK (Vascular endothelial growth factor-receptor tyrosine kinase), AKT1 kinase, AKT2 kinase, AKT3 kinase, PK (Pyruvate kinase) and Tumor M2-pyruvate kinase, but not always limited thereto and this kit is effective for measuring almost every phosphorylation by any kinase.

It is also preferred for the kit for the detection of phosphorylation of the invention to include an additional protein kinase as a control.

The present invention also provides a method for measuring phosphorylation using the kit for the detection of phosphorylation of the invention.

The present invention provides a method for measuring phosphorylation comprising the following steps:

1) Mixing sample with [γ-³²P]ATP;

2) Inducing phosphorylation after treating the sample mixture prepared in step 1) with a biochip;

3) Washing the biochip of step 2); and

4) Measuring phosphorylation level by sensitizing the biochip of step 3).

In the above method, the sample of step 1) can be selected from the group consisting of cell and tissue extracts, fraction or cell culture medium, cell homogenate, crude extract of cells or tissues, various secreting fluids such as urine, sweat, saliva, and tear and body fluids including blood, blood plasma, lymph and serum and every biological samples that can be accepted by those in the art can be used.

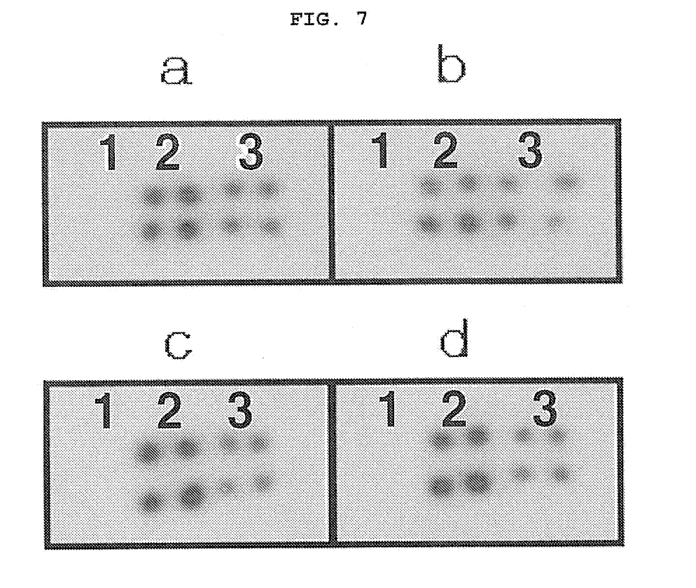

In the above method, the biochip of step 2) can be treated with a blocking solution but it is preferred not to treat with such blocking solution because signals can be obtained without noise, without the treatment of a blocking solution. The present inventors integrated E. coli malic enzyme-kemptide fusion protein and kemptide on the aldehyde treated slide glass and investigated blocking effect using different solutions in the blocking stage before inducing phosphorylation. As a result, clear spots were confirmed not only on the glasses treated with 1% BSA, 1% glycine and 10% glycerol but also on the glass not treated, confirming that the method of the invention is successful without using a blocking solution (see FIG. 7).

The problem of the conventional method is that when kinase specific substrate peptides or low molecular proteins are fixed, these target peptides or proteins would be buried by BSA, a blocking material used to prevent non-specific fixation. However, the method of the invention saves time and brings economic effects by omitting blocking process.

In the above method, the reaction of the sample of step 2) with the biochip is preferably performed at 30° C.˜37° C. for 30 minutes˜1 hour in a humid chamber, and one hour reaction is more preferred. However, the reaction time can vary considering the specificity of the sample to kinase and the substrate used.

In the above method, the method for sensitization of the biochip of step 4) is preferably the sensitization on X-ray film or by fluorescence analyzer, but not always limited thereto. Sensitization time is preferably 12˜24 hours but not always limited thereto.

Sensitization time can vary according to the specificity of the sample to kinase and the substrate used.

In the case of the conventional fluorescence ELISA, total 7 stages are required from the beginning of the experiment to the detection. However, the method for measuring phosphorylation of the invention requires only a simple chip surface treatment process for substrate fixation and enables the detection of one-pot labeled radioisotope during the phosphorylation of substrate, suggesting that the method of the invention is very simple and fast.

The conventional fluorescence detection is an indirect method, in which a specific amino acid of a substrate was phosphorylated first, and then the phosphorylated amino acid is reacted with a fluorescent material conjugated secondary antibody, so that accuracy of the quantitative analysis by this method is not satisfactory. However, the method for measuring phosphorylation of the present invention is characterized by direct conjugation of a radioisotope to a substrate, indicating that the detection result will be more accurate and high-sensitive detection is expected since the method enables the detection with an infinitesimal concentration.

The present invention further provides a screening method for the kinase specific substrate using the biochip coated with an active group and a kinase mixed with [γ-³²P]ATP. More precisely, the present invention provides a screening method for the kinase specific substrate in the sample which comprises the following steps:

1) Preparing a biochip for substrate analysis by integrating a sample on the board surface coated with an active group;

2) Inducing phosphorylation by treating kinase and [γ-³² P]ATP to the biochip of step 1);

3) Washing the biochip of step 2); and

4) Measuring the level of phosphorylation by sensitizing the biochip of step 3).

The above method can additionally include a step of quantifying the said substrate in the sample by using a biochip integrated with a certain concentration of the substrate.

In step 1), the sample is exemplified by cell culture medium, cell homogenate, crude extract of cells or tissues, various secreting fluids such as urine, sweat, saliva, and tear and body fluids including blood, blood plasma, lymph and serum, and it is preferred to fix this sample directly on the board. The preferable diameter of the spot of the sample is 40˜60 μm, the distance between spots is 300˜500 μm, and the preferable concentration is 1 nl per spot, but not always limited thereto.

In step 1), the board is exemplified by glass, plastic, metal, or silicon but not always limited thereto.

In step 1), the active group is selected from the group consisting of amine group, aldehyde group, carboxyl group and thiol group but not always limited thereto.

In step 2), the biochip can be treated with a blocking solution but not necessarily. Even without treatment of a blocking solution, signals can be obtained without noises, so it is preferred not to treat a blocking solution thereto.

In step 2), the kinase is reacted with the biochip at 30° C.˜37° C. for 30 minutes˜1 hour in a humid chamber, and one hour reaction is more preferred.

But the reaction time can vary according to the specificity of sample to the kinase.

In step 4), the method for sensitization of the biochip is preferably the sensitization on X-ray film or with fluorescence analyzer, but not always limited thereto. In the above method, Sensitization time is preferably 12˜24 hours but not always limited thereto. The sensitization time can also vary according to the specificity of the sample to the kinase.

Up to date, Western blot analysis has been most common for screening of a substrate. However, the method of the invention using the radioisotope [γ-³²P]ATP and kinase facilitates screening and quantification of a substrate in a sample with high-sensitivity but simple processes.

Practical and presently preferred embodiments of the present invention are illustrative as shown in the following Examples.

However, it will be appreciated that those skilled in the art, on consideration of this disclosure, may make modifications and improvements within the spirit and scope of the present invention.

### Example 1

### Preparation of Malic Enzyme-Kemptide Fusion Protein

### <1-1> Cloning of E. Coli Malic Enzyme-Kemptide Fusion Protein

To produce E. coli malic enzyme kemptide fusion recombinant protein, a novel strain was first generated.

To amplify sfcA gene (malic enzyme) of E. coli, PCR was performed by using the chromosomal DNA of E. coli W3110 as a template with a sense (5′ CATGCCATGGGCATCACCATCATCACCATGATATTCAAAAAAGAGTG; SEQ. ID. NO: 1) and an antisense (5′-GCTCTAGATTAGCCCAGGCTCGCACGACGCAGGATGGAGGCGGTA; SEQ. ID. NO: 2) primers. PCR was performed with 2.0 unit Taq DNA polymerase (50 mM KCl, 10 mM Tris-HCl, pH 9.0, 1.5 mM MgCl₂, 0.01% gelatin, 0.1% Triton X-100), 0.4 mM dNTP and the above primers using Palm-cycler (Corbett Life Science, USA) as follows; predenaturation at 94° C. for 5 minutes, denaturation at 94° C. for 1 minute, annealing at 55° C. for 1 minute, polymerization at 72° C. for 1 minute, 30 cycles from denaturation to polymerization, and final extension at 72° C. for 5 minutes. The PCR product obtained above was electrophoresed on 1% agarose gel, followed by staining with EtBr (Ethidium Bromide) for observation. The amplified right size DNA (1.8 kb) was purified with EasyTrap ver.2 (Takara Bio Inc., Japan). The purified PCR product was fused to kemptide, and digested with NcoI and XbaI. The PCR product fused with kemptide was ligated to the plasmid pTrc99A (Pharmacia, Sweden) digested with the same enzymes, followed by transformation to E. coli BL21(DE3) to prepare a novel strain for the production of E. coli malic enzyme-kemptide fusion recombinant protein.

### <1-2> Production and Purification of E. Coli Malic Enzyme-Kemptide Fusion Protein

The strain generated in Example <1-1> was seeded in a 500 ml Erlenmeyer flask containing 200 ml of LB medium (tryptone 10 g/L, yeast extract 5 g/L, NaCl 5 g/L) and then cultured at 37° C. with 200 rpm. The antibiotic, ampicillin, was added at the final concentration of 50 μg/ml. The cells were cultured until OD₆₀₀ reached 0.6. IPTG was added at the final concentration of 1 mM, followed by further culture at 37° C. with 200 rpm for 3 hours. Upon completion of the culture, the cells were collected (8,000 rpm, 10 minutes, 4° C.) and used for purification. The collected cells were suspended in PBS (200 mM NaCl, 3 mM KCl, 2 mM KH₂PO₄, 1 mM Na₂HPO₄, pH 7.5), followed by cell lysis by ultrasonicator. Centrifugation was performed to eliminate cell debris. E. coli malic enzyme-kemptide fusion protein was purified by using Ni-chelating resin (GE Healthcare, Sweden) for 6-histidine tag. The purified protein was quantified by Bradford method considering BSA (bovine serum albumin) as a standard.

### Example 2

### Preparation of Biochip

First, kemptide (Promega, Madison, Wis.) or malic enzyme-kemptide fusion protein was fixed on a slid glass as a substrate. Particularly, kemptide was dissolved in kemptide solution (10% glycerol, 60% PBS, pH 7.5) at the concentration of 0.1 mg/ml and this substrate solution was integrated on the aldehyde coated slid glass by using a microarrayer [Affymetrix 417 Arrayer (Takara Shuzo, Japan)] with leaving 300 μm distance between spots (2500/1 cm²). The malic enzyme-kemptide prepared in Example 1 was also integrated on the slid glass with leaving 300 μm distance between spots (2500/1 cm²). At this time, the size of each spot was 50 μm.

The biochip integrated with substrate as described above was fixed in a 30° C. humid chamber for one hour.

### Example 3

### Determination of Kinase-Substrate Reaction Conditions

The biochip prepared in Example 2 was washed three times with washing buffer (2 mM KH2PO4, 1 mM Na₂HPO₄, 200 mM NaCl, 3 mM KCl, pH 7.5) and then reaction between the substrate and kinase was induced on the chip. Particularly, the chip was washed with kinase buffer (50 mM Tris-HCl, 10 mM MgCl₂, pH 7.5) once and then pre-incubation was performed in the kinase buffer supplemented with 100 μM of ATP. 200 μl of kinase solution (kinase buffer containing 2 μl of [γ-³²P]ATP (20 uCi) and 10 units of cAMP-dependent protein kinase) was loaded on the biochip surface, followed by reaction for one hour with covered with the cover well.

One hour later, the chip was washed three times with washing buffer and then washed again with distilled water. Centrifugation was performed at 200×g for one minute to eliminate remaining moisture completely. The reacted biochip was sensitized on X-ray film for 12˜24 hours and then phosphorylation by kinase was measured.

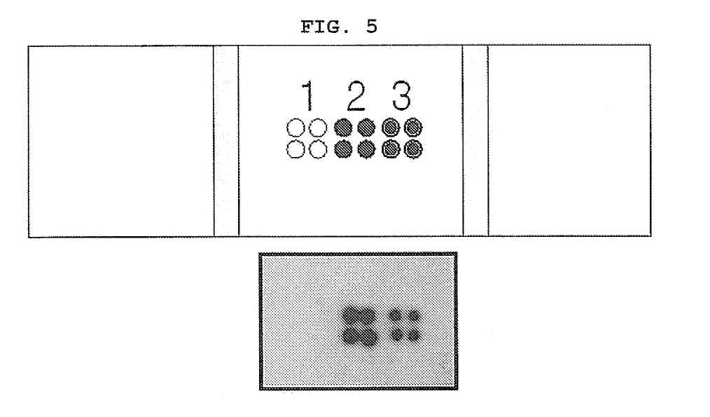

As a result, as expected, no signal was observed on No. 1 BSA spot selected as a negative control. On the contrary spot signals were clearly confirmed on the malic enzyme-kemptide fusion protein or kemptide spot, confirming the applicable effectiveness of the radioisotope [γ-³²P]ATP for phosphorylation (FIG. 5).

To confirm whether the biochip of the invention can be detected on X-ray film or by the method using fluorescence analyzer, the present inventors integrated kemptide on the chip by “RFT” (Road to Fine Tomorrow) and induced phosphorylation as follows. Photographs developed from the film after sensitization and the photographs scanned by the bioimage analyzer BAS1500 after sensitization on image plate (IP) were compared.

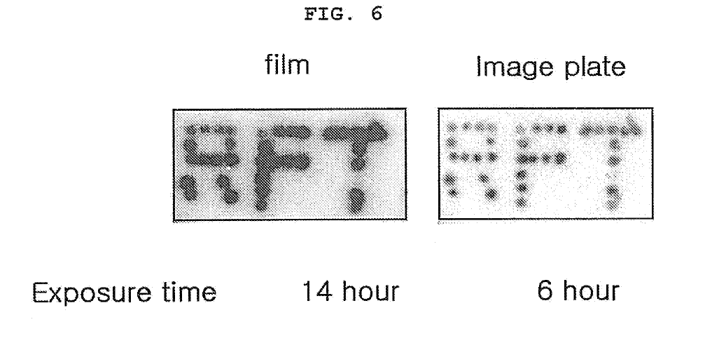

As a result, even if confirming the accurate sensitivity was hard because sensitization time was different, IP was confirmed to have 100 times as excellent detection capability as the X-ray film (FIG. 6). Thus, signals were clearly detected on IP film even with short sensitization time (approximately 43% of that of X-ray film) and moreover high-sensitive effect can be expected in early diagnosis when IP for high-sensitive detection is used. While signals on the X-ray film are getting stronger when being sensitized at −80° C., they are still strong on IP at room temperature, indicating IP is more useful.

### Comparative Example 1

### Effect of Various Blocking Solutions on the Chip Surface Treatment after Substrate Fixation

0.1 mg/ml of E. coli malic enzyme-kemptide fusion protein and 1.25 μg/ml of kemptide were loaded on the aldehyde treated slide glass to investigate the applicable effectiveness of the radioisotope [γ-³²P]ATP on the chip using 10 units/ml of PKA and 0.1 μCi/μl of [γ-³²P]ATP. Bovine serum albumin (BSA) was used as the negative control. E. coli malic enzyme-kemptide fusion protein and kemptide were respectively integrated on the aldehyde treated slide glass and blocking effect was investigated using different blocking solutions 1% BSA, 1% glycine, and 10% glycerol and without treating any blocking solution as well at 37° C. for one hour, followed by phosphorylation (10 unit/ml PKA, 0.4 μCi/μl [γ-³²P]ATP).

As a result, clear spots were observed not only when 1% BSA was treated but also when 1% glycine and 10% glycerol were treated. Even in the group treated with nothing, the clear background of a spot was confirmed (FIG. 7).

### Example 4

### IkB Detection Using Radioisotope

To detect IkB, the total protein of the lysed cells was fixed on the glass board coated with aldehyde group, resulting in the preparation of a biochip for substrate analysis. The biochip was prepared by the same manner as described in Example 2 except that the substrate was fixed on the board. The prepared biochip was washed and treated with kinase (IkB kinase; IKK) and [γ-³²P]ATP. Then, phosphorylation was measured on X-ray film.

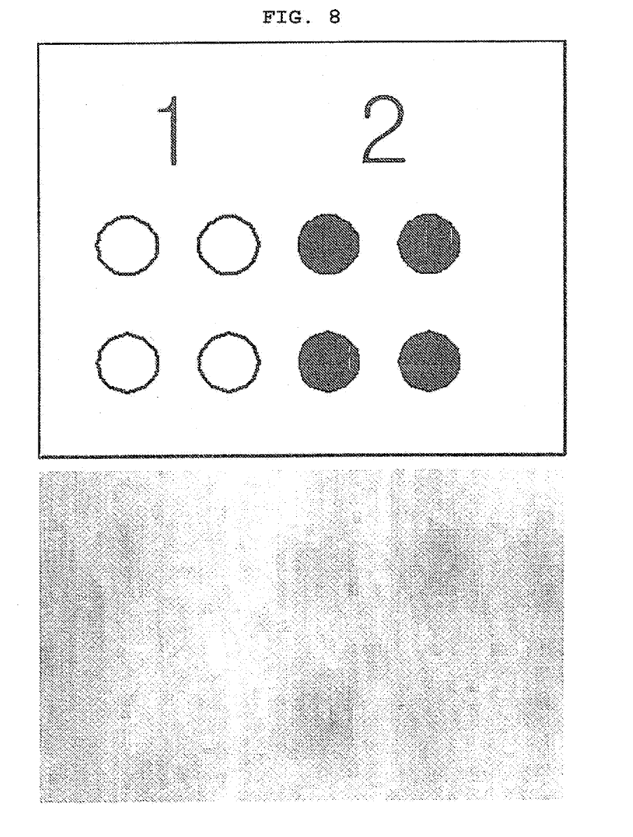

As a result, as expected, no signal was detected in #1 BSA spot, which was the negative control, whereas a clear spot signal was confirmed in the spot of the total protein of the lysed cells (FIG. 8).

### INDUSTRIAL APPLICABILITY

The biochip and the kit for the detection of phosphorylation of the present invention and the method for measuring phosphorylation using the same favor the sensitivity because of using a radioisotope, so that the chip and the kit and the method facilitate fast and easy measurement of phosphorylation even with a small amount of a sample, compared with any other conventional methods, and clear and economical result-obtainment. Since this method requires only a small amount of sample, the size of a spot is significantly small, compared with other conventional chips, suggesting that the numbers of spots acceptable in a certain area on the chip increases. Thus, fast and mass sample analysis is possible, indicating that this chip and the kit and the method can be effectively used for the analysis of the kinase activity.

### Sequence List Text

SEQ. ID. NO: 1 is the sense primer for the amplification of sfcA gene of E. coli (5′-CATGCCATGGGCATCACCATCATCACCATGATATTCAAAAAAGAGTG-3′).

SEQ. ID. NO: 2 is the antisense primer for the amplification of sfcA gene of E. coli (5′-GCTCTAGATTAGCCCAGGCTCGCACGACGCAGGATGGAGGCGGTA-3′).

What is claimed is:

1. A biochip on which the substrate of kinase is integrated on the surface of a board coated with an active group.

2. The biochip according to claim 1, wherein the substrate of kinase is directly fixed on the board.

3. The biochip according to claim 1, wherein the board is selected from the group consisting of glass, plastic, metal, and silicon.

4. The biochip according to claim 1, wherein the active group coated on the board is selected from the group consisting of amine group, aldehyde group, carboxyl group, and thiol group.

5. The biochip according to claim 1, wherein the substrate is selected from the group consisting of kemptide, malic enzyme-kemptide, protein phosphatase inhibitor-2, and Elk1 (p62 ternary complex factor).

6. The biochip according to claim 1, wherein the kinase is selected from the group consisting of Aurora kinases (BTAK and STK15), tyrosine kinase (Lyn)₇ PTK (protein tyrosine kinase), MAPK (MAP kinase), MAPKK (MAP kinase kinase), PKA (protein kinase A), PKC (protein kinase C), ERK (extracellular signal-regulated kinase), CAM KΠ (calcium/Calmodulin-dependent protein kinase), MEKK (MAP/ERK kinase kinase), JNK (c-Jun N-terminal kinase), SAPK (stress-activated protein kinase), p38K (p38 kinase), phosphatase 2B, cPKC (conventional protein kinase), Serine Kinase IKKβ, Ab1K (Ab1 kinase), BTK (Bruton tyrosine kinase), CDK (cyclin-dependent kinase), VEGF-RTK (Vascular endothelial growth factor-receptor tyrosine kinase) AKT1 kinase, AKT2 kinase, AKT3-kinase, PK (Pyruvate kinase), and Tumor M2-pyruvate kinase.

7. The biochip according to claim 1, wherein the diameter of a spot of the integrated substrate is 40˜60 μm and the distance between spots is 300˜500 μm.

8. The biochip according to claim 1, wherein the concentration of the substrate integrated is up to 1 nl per spot.

9. A kit for the detection of phosphorylation containing the biochip of claim 1 and [γ-³²P]ATP.

10. The kit for the detection of phosphorylation according to claim 9, wherein the kit additionally contains protein kinase as a positive control.

11. A method for measuring phosphorylation comprising the following steps:
1) Mixing a sample with [γ-³²P]ATP;
2) Inducing phosphorylation after treating the sample mixture prepared in step 1) with a biochip;
3) Washing the biochip of step 2); and
4) Measuring phosphorylation level by sensitizing the biochip of step 3).

12. The method for measuring phosphorylation according to claim 11, wherein the sample of step 1) is selected from the group consisting of cell culture medium, cell homogenate, crude extract of cells or tissues, various secreting fluids such as urine, sweat, saliva, and tear and body fluids such as blood, blood plasma, lymph and serum.

13. The method for measuring phosphorylation according to claim 11, wherein the biochip of step 2) is not treated with any blocking solution.

14. The method for measuring phosphorylation according to claim 11, wherein the reaction time of step 2) is 30˜60 minutes at 30° C. or at 37° C.

15. The method for measuring phosphorylation according to claim 11, wherein the sensitization of step 4) is performed on X-ray film or by fluorescence analyzer.

16. A screening method for the kinase specific substrate in a sample which comprises the following steps:
1) Preparing a biochip for substrate analysts by integrating a sample on the board surface coated with an active group;
2) Inducing phosphorylation by treating kinase and [γ-³²P]ATP to the biochip of step 1);
3) Washing the biochip of step 2); and
4) Measuring the level of phosphorylation by sensitizing the biochip of step 3).

17. The screening method for the kinase specific substrate according to claim 16, wherein the substrate is IkB.

18. The screening method for the kinase specific substrate according to claim 16, wherein the method additionally includes the step of quantifying the substrate in the sample using the biochip integrated with the substrate at a certain concentration.

19. The screening method for the kinase specific substrate according to claim 16, wherein the sample of step 1) is selected from the group consisting of cell culture medium, cell homogenate, crude extract of cells or tissues, various secreting fluids such as urine, sweat, saliva, and tear and body fluids such as blood, blood plasma, lymph and serum.

20. The screening method for the kinase specific substrate according to claim 16, wherein the sample of step 1) is fixed directly on the board.

21. The screening method for the kinase specific substrate according to claim 16, wherein the diameter of a spot of the sample of step 1) is 40˜60 μm and the distance between spots is 300˜500 μm.

22. The screening method for the kinase specific substrate according to claim 16, wherein the concentration of the sample of step 1) is up to 1 nl per spot.

23. The screening method for the kinase specific substrate according to claim 16, wherein the board of step 1) is selected from the group consisting of glass, plastic, metal and silicon.

24. The screening method for the kinase specific substrate according to claim 16, wherein the active group of step 1) is selected from the group consisting of amine group, aldehyde group, carboxyl group and thiol group.

25. The screening method for the kinase specific substrate according to claim 16, wherein the kinase of step 2) is selected from the group consisting of Aurora kinases (BTAK and STK15), tyrosine kinase; Lyn, PTK (protein tyrosine kinase), MAPK (MAP kinase), MAPKK (MAP kinase kinase), PKA (protein kinase A), PKC (protein kinase C), ERK (extracellular signal-regulated kinase), CAM KΠ (calcium/Calmodulin-dependent protein kinase), MEKK (MAP/ERK kinase kinase), JNK (c-Jun N-terminal kinase), SAPK (stress-activated protein kinase), p38K (p38 kinase), phosphatase 2B, cPKC (conventional protein kinase), Serine Kinase IKKβ, Ab1K (Ab1 kinase), BTK (Bruton tyrosine kinase), CDK (cyclin-dependent kinase), VEGF-RTK (Vascular endothelial growth factor-receptor tyrosine kinase), AKT1 kinase, AKT2 kinase, AKT3-kinase, PK (Pyruvate kinase) and Tumor M2-pyruvate kinase.

26. The screening method for the kinase specific substrate according to claim 16, wherein the biochip of step 2) is not treated with any blocking solution.

27. The screening method for the kinase specific substrate according to claim 16, wherein the reaction time of step 2) is 30˜60 minutes at 30° C. or 37° C.

28. The screening method for the kinase specific substrate according to claim 16, wherein the sensitization of step 4) is performed on X-ray film or by fluorescence analyzer.


SEQUENCE LISTING (2 sequences)

SEQ ID NO: 1 - DNA, 47 bp, Artificial Sequence
  primer 1
catgccatgggcatcaccatcatcaccatgatattcaaaaaagagtg

SEQ ID NO: 2 - DNA, 45 bp, Artificial Sequence
  primer 2
gctctagattagcccaggctcgcacgacgcaggatggaggcggta